(19) United States
(12) Patent Application Publication
(10) Pub. No.: US 2007/0252761 A1
(43) Pub. Date: Nov. 1, 2007

(54) METHOD AND ARRANGEMENT FOR BASE STATION LOCATION, BASE STATION SYNCHRONIZATION, AND MOBILE STATION LOCATION

(76) Inventors: Havish Koorapaty, Cary, NC (US); Abdulrauf Hafeez, Cary, NC (US)

Correspondence Address: ERICSSON INC., 6300 LEGACY DRIVE, M/S EVR 1-C-11, PLANO, TX, 75024, US

(21) Appl. No.: 11/534,987

(22) Filed: Sep. 25, 2006

Related U.S. Application Data
(60) Provisional application No. 60/745,774, filed on Apr. 27, 2006.

(51) Int. Cl. G01S 3/02; G01S 5/14

(52) U.S. Cl. 342/464; 342/357.06

(57) ABSTRACT

A complete positioning solution for mobile communications networks such as WLAN or ad-hoc/multi-hop networks, which lack location information for one or more base stations. A method and arrangement computes the locations and transmit timing of the base stations utilizing GPS location information and GPS timing information from multiple GPS-capable mobile stations operating in the service areas of such base stations. Once the base station locations and transmit timing are known, this information is used in conjunction with the reported GPS information to synchronize transmissions from the base stations using a marker in a downlink transmission such as the start of a particular frame. Finally, the locations and transmit timing from three or more base stations are used to determine the locations of mobile stations that are not GPS-capable.

### CROSS-REFERENCE TO RELATED APPLICATIONS

This application claims benefit of U.S. Provisional Application No. 60/745,774 filed Apr. 27, 2006, the disclosure of which is incorporated herein by reference.

### STATEMENT REGARDING FEDERALLY SPONSORED RESEARCH OR DEVELOPMENT

NOT APPLICABLE

### REFERENCE TO SEQUENCE LISTING, A TABLE, OR A COMPUTER PROGRAM LISTING COMPACT DISC APPENDIX

NOT APPLICABLE

### BACKGROUND OF THE INVENTION

This invention relates to wireless communication systems. More particularly, and not by way of limitation, the invention is directed to a complete positioning and synchronizing solution for locating base stations, synchronizing base stations, and locating mobile stations in wireless communication networks.

The importance of mobile station (MS) position estimation, due to requirements for enhanced 911 emergency services, has increased the likelihood of MSs having Global Positioning System (GPS) receivers capable of defining the location of the MS to within a few meters. This trend is likely to continue in the near future as operators consider providing location-based services to customers. The use of GPS for mobile location estimation has already been specified in most major standards.

Published U.S. Patent Application No. 200410092275 describes a procedure for using the GPS location information from an MS to synchronize transmissions from base stations in the network. In such a procedure, the MS's serving base station sends a request to the MS to compute its position and determine the GPS time corresponding to the time at which the MS received a frame transmitted by the base station. The MS sends this information to the base station, which calculates a correction to its transmission timing based on a propagation delay calculated from the known position of the base station and the information received from the MS. When this procedure is performed for all of the base stations in the network, the base stations are all synchronized to GPS time.

This procedure breaks down, however, if any piece of information is missing. For example, in WLAN or ad-hoc/multi-hop networks, the location of the base station may not be known. Without this crucial piece of information, the synchronization procedure cannot be performed.

It is also well known in the art to determine the location of an MS using triangulation from three different base stations of known location. The location of the MS can be determined from time of arrival (TOA) and angle of arrival (AOA) information collected at the three base stations. Without known locations for the base stations, however, this location procedure cannot be performed.

What is needed in the art is a complete positioning and synchronizing solution for mobile communications networks that overcomes the shortcomings of the prior art. The present invention provides such a solution.

### BRIEF SUMMARY OF THE INVENTION

The present invention provides a complete positioning solution for mobile communications networks. In networks such as WLAN or ad-hoc/multi-hop networks, the network may lack location information for one or more base stations. The present invention provides a method and arrangement for determining the location of a base station when GPS-capable MSs are operating in the service area of the base station. Once the location information for the base station is known, the information is used in conjunction with reported GPS location information and GPS time information from the GPS-capable MSs to synchronize transmissions from the base station or to determine time offsets between base station transmissions. Finally, transmissions from three or more base stations are used to determine the locations of MSs that are not GPS-capable.

In one aspect, the present invention is directed to a method of determining location information for a base station in a wireless communication system. The method includes receiving in the base station, GPS location and timing information from at least three mobile stations having GPS capability; and computing the location information for the base station utilizing the received GPS location and timing information.

In another aspect, the present invention is directed to a method of synchronizing transmissions from a base station in a wireless communication system in which the location of the base station is not known. The method determines location information for the base station by receiving information in the base station from at least three reporting mobile stations having GPS capability and computing the location information for the base station utilizing the received information. The received information includes for each reporting mobile station, GPS location information, an identity of a marker in a received downlink frame, and the GPS time at which the mobile station received the marker. The method also includes the steps of calculating a distance from the base station to a given reporting mobile station based on the received GPS location of the given mobile station and the computed location information for the base station; computing a propagation delay between the base station and the given mobile station; computing a GPS time corresponding to the transmission time for the marker; and adjusting the base station transmission timing to satisfy a pre-determined relationship between the base station's transmission time for the marker and GPS time.

In another aspect, the present invention is directed to a method of determining location information for a non-GPS-capable mobile station operating in a wireless communication system in which the location of a given base station in communication with the non-GPS-capable mobile station is not known. The method includes the steps of computing location information for the given base station based upon GPS location and timing information received from at least three GPS-capable mobile stations; synchronizing transmissions or determining the time offsets of transmissions from the given base station and at least two other base stations in communication with the non-GPS-capable mobile station utilizing the computed location information for the given base station and the GPS location and time information received from the GPS-capable mobile stations; and determining the location information for the non-GPS-capable mobile station utilizing the synchronized transmissions or transmissions with known time offsets and the locations of the given base station and the at least two other base stations in communication with the non-GPS-capable mobile station.

In another aspect, the present invention is directed to an arrangement in a base station for determining location information for the base station. The arrangement includes communication means for receiving GPS location and timing information from at least three mobile stations having GPS capability; and a location computation unit for computing the location information for the base station utilizing the received GPS location and timing information.

In another aspect, the present invention is directed to a transmission synchronizing arrangement in a base station in a wireless communication system in which location information for the base station is not known. The arrangement includes communication means for receiving information in the base station from at least three reporting mobile stations having GPS capability. The received information includes for each reporting mobile station, GPS location information, an identity of a marker in a received downlink frame, and the GPS time at which the mobile station received the marker. The arrangement also includes a location computation unit for computing the location information for the base station utilizing the received information; means for computing a propagation delay between the base station and a given mobile station based on the received GPS location of the given mobile station and the computed location information for the base station; means for computing a GPS time corresponding to the transmission time for the marker based on the GPS time at which the mobile station received the marker and the computed propagation delay; and means for adjusting the base station transmission timing to satisfy a pre-determined relationship between the base station's transmission time for the marker and GPS time.

In another aspect, the present invention is directed to an arrangement for determining location information for a non-GPS-capable mobile station operating in a wireless communication system in which the location of a given base station in communication with the non-GPS-capable mobile station is not known. The arrangement includes a location computation unit for computing location information for the given base station based upon GPS location and timing information received from at least three GPS-capable mobile stations; means for synchronizing transmissions or determining time offsets of transmissions from the given base station and at least two other base stations in communication with the non-GPS-capable mobile station utilizing the computed location information for the given base station and the GPS location and time information received from the GPS-capable mobile stations; and a mobile location unit for determining the location information for the non-GPS-capable mobile station utilizing the synchronized transmissions or transmissions with known time offsets and the locations of the given base station and the at least two other base stations in communication with the non-GPS-capable mobile station.

In another aspect, the present invention is directed to a method of determining a transmission time of a downlink signal transmitted from a base station in a wireless communication system in which the location of the base station is known. The method includes receiving information in the base station or another network node from at least one reporting mobile station having GPS capability. The information includes for each reporting mobile station, GPS location information, an identity of a marker in a received downlink frame, and a GPS time at which the mobile station received the marker. The method also includes computing in the base station or other network node, the GPS time corresponding to the base station's transmission time for the marker utilizing the received information.

### BRIEF DESCRIPTION OF THE SEVERAL VIEWS OF THE DRAWING

In the following, the essential features of the invention will be described in detail by showing preferred embodiments, with reference to the attached figures in which:

FIG. 1 is a flow chart illustrating the steps of a total positioning solution for a cellular telecommunication system in an exemplary embodiment of the present invention;

FIG. 2A is a flow chart illustrating the steps of a first exemplary method of determining the location of a base station utilizing information from GPS-capable mobile stations in accordance with the teachings of the present invention;

FIG. 2B is a flow chart illustrating the steps of a second exemplary method of determining the location of a base station utilizing information from GPS-capable mobile stations in accordance with the teachings of the present invention;

FIG. 3 is a flow chart illustrating the steps of an exemplary method of synchronizing base station transmissions in a cellular telecommunication system utilizing the computed location of the base station and information from GPS-capable mobile stations in accordance with the teachings of the present invention;

FIG. 4 is a flow chart illustrating the steps of an exemplary method of determining the location of a base station utilizing information from three or more mobile stations where some or all of the mobile stations are non-GPS-capable mobile stations;

FIG. 5 is a flow chart illustrating the steps of an exemplary method of locating a non-GPS-capable mobile station utilizing the synchronized base station transmissions and the computed locations of the base stations in accordance with the teachings of the present invention; and

FIG. 6 is a simplified block diagram of an embodiment of the system of the present invention.

### DETAILED DESCRIPTION OF THE INVENTION

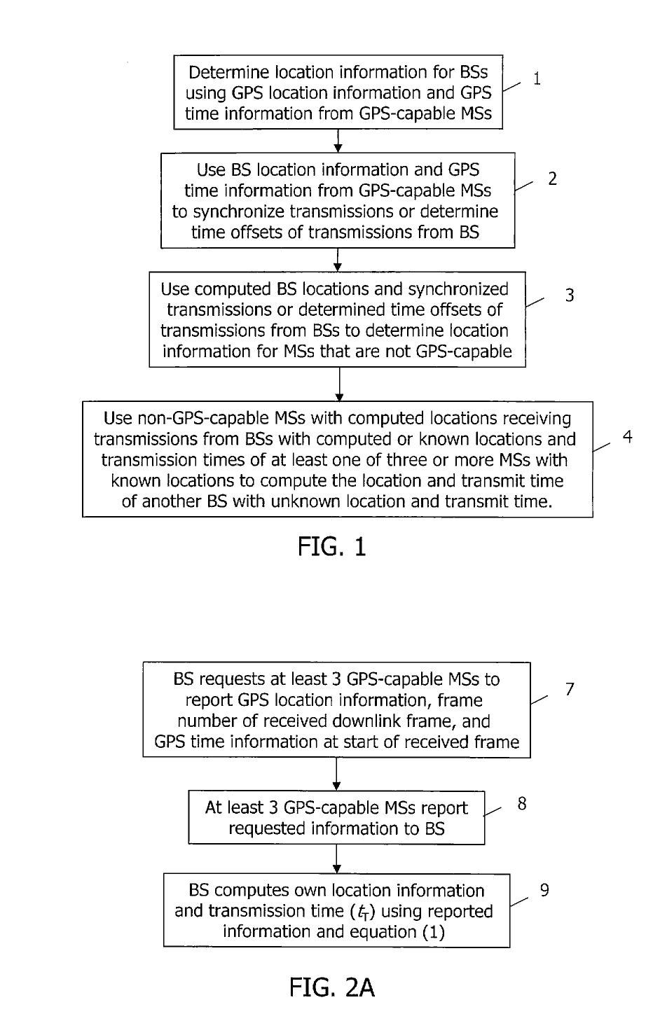

FIG. 1 is a flow chart illustrating the steps of a total positioning solution for a cellular telecommunication system in an exemplary embodiment of the present invention. In wireless networks such as WLAN or ad-hoc/multi-hop networks, the location of the base station may not be known. Therefore, traditional methods of locating non-GPS-capable mobile stations using triangulation from multiple base stations cannot be utilized. In the present invention, this problem is overcome by determining at step 1, location information for each base station utilizing GPS location information and GPS time information from GPS-capable mobile stations in communication with the base station. At step 2, the computed base station location information and the GPS time information are utilized to synchronize transmissions or determine time offsets of transmissions from the base station to an alignment relative to GPS time. At step 3, the base station locations and synchronized transmissions or transmissions with known time offsets are utilized to determine location information for non-GPS-capable mobile stations. At step 4, the computed location information for non-GPS-capable mobile stations, receiving transmissions from base stations with computed or previously known location and transmit time information, is used to compute the location and transmit time of another base station of unknown location and transmit time. The location of the other base station may be determined even though the other base station is not in communication with three GPS-capable mobile stations. The location may be computed using only non-GPS capable mobile stations whose location has been previously computed in accordance with the present invention, or some non-GPS capable mobile stations and some GPS-capable mobile stations. Location information may be computed in the base station or other network node.

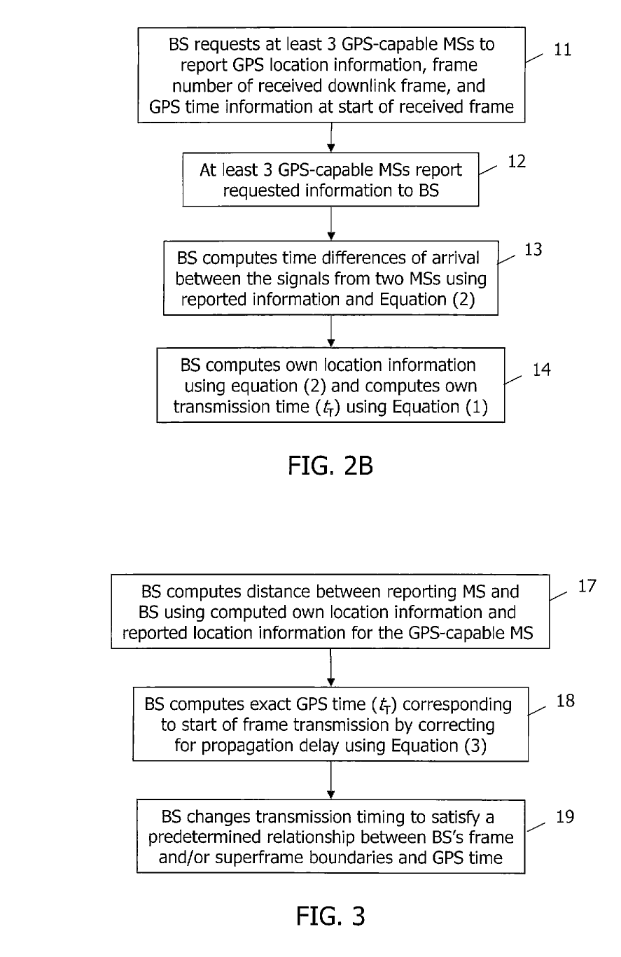

FIG. 2A is a flow chart illustrating the steps of a first exemplary method of determining the location of a base station utilizing information from GPS-capable mobile stations in accordance with the teachings of the present invention. When a BS is serving three or more MSs that have an MS-based or stand-alone GPS capability, the location of the serving BS can be determined. At step 7, the serving BS sends a request to each of the GPS-capable MSs to compute and report its own GPS location and GPS time, and to report a time stamp indicating the GPS time at which the MS received a particular marker in the signal transmitted by the BS. The marker may be, for example, the start of a frame or a slot. At step 8, at least three GPS-capable mobile stations report the requested information to the base station. At step 9, the base station uses the reported information from N mobile stations to compute its own location information (x, y) and time of transmission t_{T} using Equation (1):

$${t}_{R}^{i} = {t}_{T} + \frac{\sqrt{{( x - {x}_{i} )}^{2} + {( y - {y}_{i} )}^{2}}}{c} , 1 \leq i \leq N \qquad ( 1 )$$

where t is the time of reception of the marker at the MSᵢ; (xᵢ, yᵢ) is the location for each of the N MSs; and c is the speed of light. The factors t_{R}ⁱ and (xᵢ, yᵢ) are reported by the MSs, and c and N are known. Hence, when N is at least three, there are at least as many or more equations than unknowns and the position coordinates (x, y) for the BS and the exact time of transmission t_{T}, can be computed.

FIG. 2B is a flow chart illustrating the steps of a second exemplary method of determining the location of a base station utilizing information from GPS-capable mobile stations in accordance with the teachings of the present invention. In this embodiment, the base station computes time differences of arrival (TDOA) between the signals from at least two MSs in order to compute the base station's own location information. At step 11, the serving BS sends a request to each of the GPS-capable MSs to compute and report its own GPS location and GPS time, and to report a time stamp indicating the GPS time at which the MS received a particular marker in the signal transmitted by the BS. At step 12, at least three GPS-capable mobile stations report the requested information to the base station. At step 13, the base station utilizes the reported information and Equation (2) below to compute time differences of arrival between the signals from two mobile stations.

The time differences of arrival may be computed from the reported measurements and are related to the base station and mobile station locations as follows:

$${t}_{R}^{i + 1} - {t}_{R}^{i} = \frac{\sqrt{{( x - {x}_{i + 1} )}^{2} + {( y - {y}_{i + 1} )}^{2}}}{c} - \frac{\sqrt{{( x - {x}_{i} )}^{2} + {( y - {y}_{i} )}^{2}}}{c} , \\ 1 \leq i \leq N - 1 \qquad ( 2 )$$

At step 14, this equation is solved for two reporting mobile stations. The position coordinates of the base stations (x, y), which are the only unknowns, may then be calculated. In addition, the base station may use Equation (1) to compute its own transmission time.

When the exemplary method of FIG. 2A is utilized for determining the location of the base station, the exact GPS time (t_{T}) corresponding to the start of the downlink frame transmission is implicitly computed. Base station transmissions can then be synchronized by having the base station change its transmission timing to satisfy a pre-determined relationship between the base station's frame and/or superframe boundaries and GPS time.

FIG. 3 is a flow chart illustrating the steps of an exemplary method of synchronizing base station transmissions in a cellular telecommunication system utilizing the computed location of the base station and information from GPS-capable mobile stations in accordance with the exemplary method shown in FIG. 2B. Once the position of the base station has been determined, the position of the base station may subsequently be used to synchronize base station transmissions. At step 17, the base station computes the distance between a reporting GPS-capable mobile station and the base station utilizing the base station's own computed location information and the reported location information for the GPS-capable mobile station. At step 18, the base station computes the exact GPS time (t_{T}) corresponding to the start of the downlink frame transmission by correcting for the propagation delay utilizing Equation (3) below. At step 19, the base station changes its transmission timing to satisfy a pre-determined relationship between the base station's frame and/or superframe boundaries and GPS time.

The distance between the base station and the reporting mobile station is used to compute the exact transmission time t, by accounting for propagation delay according to:

$${t}_{T} = {t}_{G} - \frac{\sqrt{{( x - {x}_{i} )}^{2} + {( y - {y}_{i} )}^{2}}}{c} \qquad ( 3 )$$

where t_{T}, is the time of transmission of the signal at the BS, t_{G} is the GPS time reported by the MS, \sqrt{(x−xᵢ)²+(y−yᵢ)²} is the distance between the MS with coordinates (xᵢ, yᵢ) and the BS with coordinates (x,y), and c is the speed of light.

The above procedures may be periodically carried out by the base station to maintain synchronization. The timing updates derived from this procedure can be used as input to a tracking loop that maintains synchronization of base station transmissions with GPS time. Alternately, the base station can keep its original transmission timing and keep track of the GPS time corresponding to this original transmission timing. Equivalently it can keep track of the time offset between the current transmission timing and the desired timing according to the pre-determined relationship between frame/superframe timing and GPS time.

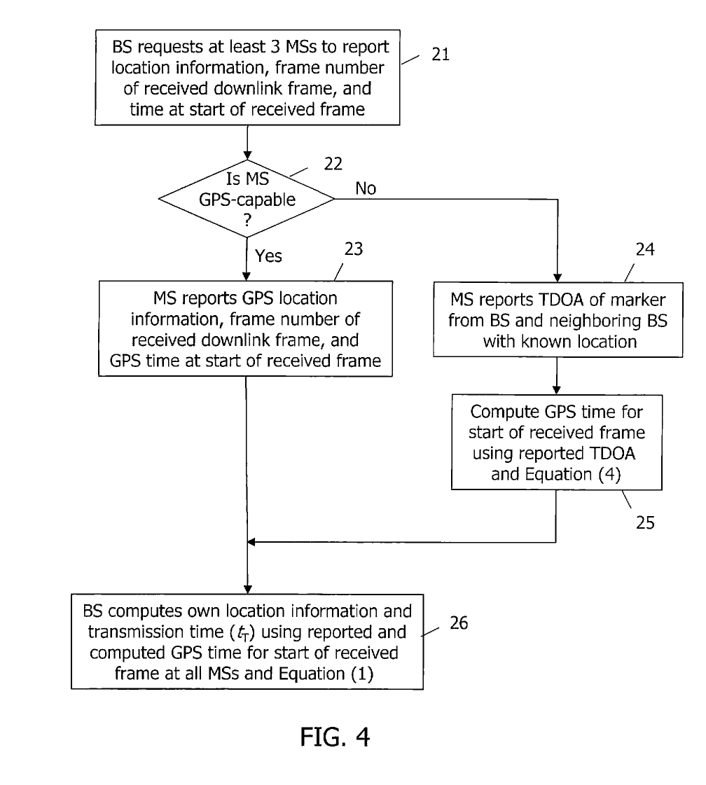

FIG. 4 is a flow chart illustrating the steps of an exemplary method of determining the location of a base station utilizing information from three or more mobile stations where some or all of the mobile stations are non-GPS-capable mobile stations. The locations of the non-GPS-capable mobile stations have been computed according to the teachings of the present invention, and the non-GPS-capable mobile stations are capable of receiving transmissions from other base stations with known location and transmit time information computed in accordance with the teachings of the present invention. At step 21, the serving BS sends a request to each of the MSs to report its location information and the time corresponding to the reception of a particular marker such as the start of a received downlink frame or slot. At step 22, it is determined whether the MS is a GPS-capable MS. If so, the method moves to step 23 where the GPS-capable MS reports its GPS location computed using signals received from GPS satellites. The GPS-capable MS also reports the frame number of the received downlink frame and the GPS time at the start of the received frame (or at the marker if different).

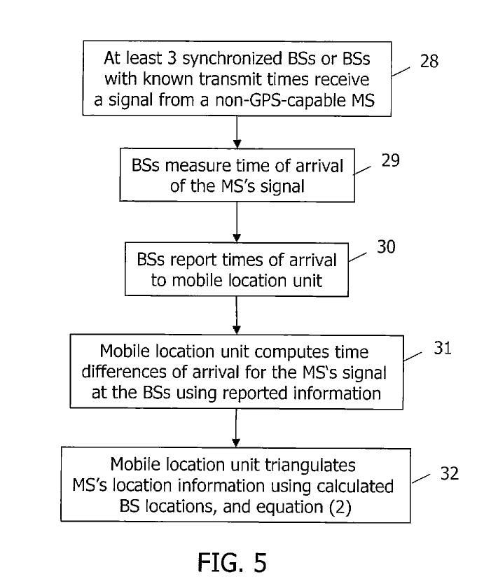

However, if the MS is a non-GPS-capable MS, the method moves to step 24 where the non-GPS-capable MS reports its location as previously computed according to the teachings of the present invention (as shown in FIG. 5) and the time difference of arrival (TDOA) of a particular marker transmitted by the BS and a neighboring BS with known location and transmit time information. At step 25, the serving BS or another node in the network computes the GPS time corresponding to a particular marker for the non-GPS-capable mobile stations using the reported time difference of arrival information, the known GPS transmit time information of the neighboring BS, and Equation (4):

$${t}_{R}^{i} = {t}_{D} + {t}_{T} + \frac{\sqrt{{( {x}^{′} - {x}_{i} )}^{2} + {( {y}^{′} - {y}_{i} )}^{2}}}{c} \qquad ( 4 )$$

where t_{R}ⁱ, is the desired GPS time corresponding to the particular marker, t_{T}, is the time of transmission of the signal at the neighboring BS with known location, t_{D} is the time difference reported by the MS, \sqrt{(x′−xᵢ)²+(y′−yᵢ)²} is the distance between the MS with coordinates (xᵢ, yᵢ) and the neighboring BS with coordinates (x′,y′), and c is the speed of light. At step 26, the base station uses the reported and computed information from N mobile stations to compute its own location information (x, y) and time of transmission t_{T} using Equation (1) as described previously.

FIG. 5 is a flow chart illustrating the steps of an exemplary method of locating a non-GPS-capable mobile station utilizing the synchronized base station transmissions or transmissions with known time offsets and the computed locations of the base stations in accordance with the teachings of the present invention. At step 28, at least three synchronized base stations or base stations with known transmit time offsets receive a signal from a non-GPS-capable mobile station. At step 29, the base stations measure the time of arrival of the mobile station's signal. At step 30, the base stations report the times of arrival to a mobile location unit. If the base stations are not synchronized, then the times of arrival are adjusted according to the previously determined time offsets between the base station transmissions and the desired transmission time based on the pre-determined relationship between transmission time and GPS time. At step 31, the mobile location unit computes the time differences of arrival for the mobile station's signal at the base stations using the reported information. At step 32, the mobile location unit triangulates the mobile station's location information using the calculated location information for each base station, the determined time offsets between base station transmissions, and Equation (2). It will be apparent to those skilled in the art that the above procedure can also be executed with the non-GPS-capable mobile station receiving signals from at least three base stations, and measurements being made at the mobile station.

The techniques described herein enable the propagation of location and timing information throughout the network. In areas where GPS-capable mobile stations are plentiful, the GPS locations and GPS times reported from the GPS-capable mobile stations can be utilized to compute the locations of base stations and to synchronize the base stations. In areas where GPS-capable mobile stations are not plentiful, non-GPS-capable mobile stations report locations computed according to the present invention together with the time difference of arrival of a particular marker transmitted by a serving base station of unknown location and a neighboring base station with known location and transmit time information. GPS time for the mobile stations can then be calculated utilizing Equation (4) and used to compute the location of the serving base station utilizing Equation (1). In this manner, location and timing information is propagated throughout the network. It should also be understood that any base station may be a fixed relay station, and any mobile station may be a mobile relay station.

By way of example, a scenario is described in which three base stations (BS1, BS2, and BS3) have three or more GPS-capable mobile stations in their operating areas. From the teachings of the present invention, these base stations can thus be located. A fourth base station (BS4) only has two GPS-capable mobile stations (MS1 and MS2) in its coverage area, but has a non-GPS-capable mobile station (MS3) in its operating area that can also communicate with BS1, BS2, and BS3. The location of MS3 can be determined using the previously located BS1, BS2, and BS3. Then, MS3 can be used together with MS1 and MS2 to locate BS4. Thus, location information can be iteratively propagated through the network.

In the above example, MS1 and MS2 help to provide location information by conveying the GPS time corresponding to a certain marker on the downlink. Since MS3 does not have GPS time, it conveys a measured difference in the time of arrival of this marker transmitted from both BS1 (or BS2 or BS3) and BS4. Since GPS time of transmission at BS1 is known, and the locations of BS1 and MS3 are known, the required GPS time corresponding to the reception of the marker from BS4 can be computed using Equation (4).

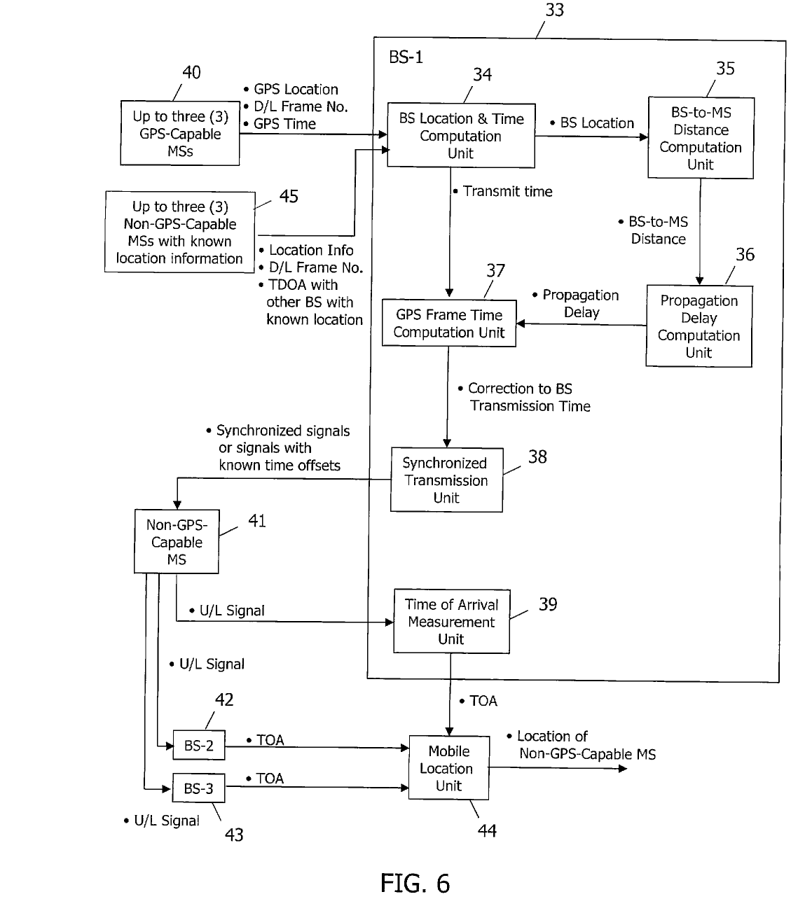

FIG. 6 is a simplified block diagram of an embodiment of the system of the present invention. A first base station (BS-1) 33 does not include a GPS receiver, and its location is unknown. BS-1 includes a BS Location Computation Unit 34, a BS-to-MS Distance Computation Unit 35, a Propagation Delay Computation Unit 36, a GPS Frame Time Computation Unit 37, a Synchronized Transmission Unit 38, and a Time of Arrival (TOA) Measurement Unit 39. In operation, up to three GPS-capable mobile stations 40 send information to the BS Location Computation Unit 34. The information includes GPS location information, a marker such as a frame number of a received downlink frame, and GPS time information at the start of the received frame. Alternatively, up to three non-GPS-capable mobile stations 45 with known location information computed according to the present invention may send their computed location information to the BS Location Computation Unit 34, together with a received downlink frame number and time difference of arrival information with another base station of known location. The BS location unit then computes the GPS time information at the start of the received frame using Equation (4).

The BS Location Computation Unit computes the BS location information and optionally the transmission time (t_{T}) using Equation (1) above, and sends the location information to the BS-to-MS Distance Computation Unit 35. If the transmission time (t_{T}) is computed, it is sent to the Synchronized Transmission Unit 38. If the transmit time (t_{T}) is not computed in the BS Location Computation Unit 34, the following operations are carried out to supply information on propagation delay necessary for the GPS Frame Time Computation Unit 37 to compute the transmission time. The BS-to-MS Distance Computation Unit computes the distance between the BS and the reporting MS and sends the computation to the Propagation Delay Computation Unit 36.

The Propagation Delay Computation Unit 36 computes the propagation delay associated with the computed BS-to-MS distance and sends the computation to the GPS Frame Time Computation Unit 37. If the transmission time (t_{T}) is not received from the BS Location Computation Unit 34, the GPS Frame Time Computation Unit 37 computes the exact GPS time corresponding to the start of the downlink frame transmission by correcting for the propagation delay utilizing Equation (3) above, and computes a correction to the BS transmission time (t_{T}) to align the BS transmission time with GPS time. This correction is sent to the Synchronized Transmission Unit 38, which changes the BS transmission timing to satisfy a predetermined relationship with GPS time. Alternatively, the synchronized transmission unit may keep track of the time offset between BS transmission time and the desired transmission time based on the predetermined relationship with GPS time without changing the BS transmission timing.

Synchronized signals or signals with known time offsets are then sent to a non-GPS-capable MS 41. The non-GPS-capable MS transmits an uplink signal, which is received by BS-1 33, BS-2 42, and BS-3 43. The TOA Measurement Unit 39 measures the TOA of the MS's signal and sends the measurement to a Mobile Location Unit (44). BS-2 and BS-3 also receive the uplink signal and send their TOA measurements to the Mobile Location Unit. The Mobile Location Unit computes time differences of arrival for the MS's signal at the BSs using the reported information, and triangulates the mobile station's location information using the time differences of arrival and known base station locations.

It should be understood that although FIG. 6 shows functional blocks 34-39 implemented within BS-1 33, these functional blocks may also be implemented in other network nodes such as base station controllers, radio network controllers, mobile switching centers, serving GPRS service nodes, mobile location centers, and the like.

GPS-capable MSs are becoming increasingly common. This fact will make the present invention even more useful in future high-capacity and data-rate systems.

Although preferred embodiments of the present invention have been illustrated in the accompanying drawings and described in the foregoing Detailed Description, it is understood that the invention is not limited to the embodiments disclosed, but is capable of numerous rearrangements, modifications, and substitutions without departing from the scope of the invention. The specification contemplates any all modifications that fall within the scope of the invention defined by the following claims.

What is claimed is:

1. A method of determining location information for a base station in a wireless communication system, said method comprising:
receiving in the base station or other network node, Global Positioning System (GPS) location and timing information from at least three mobile stations having GPS capability, and
computing in the base station or other network node, the location information for the base station utilizing the received GPS location and timing information.

2. The method according to claim 1, wherein the step of receiving GPS location and timing information includes receiving from each of the at least three mobile stations, an identity of a marker in a received downlink frame and the GPS time at which the mobile station received the marker.

3. The method according to claim 2, wherein the step of computing the location information also includes computing transmit time information for the base station, said step of computing the location and transmit time information utilizing the equation:
$${t}_{R}^{i} = {t}_{T} + \frac{\sqrt{{( x - {x}_{i} )}^{2} + {( y - {y}_{i} )}^{2}}}{c} , 1 \leq i \leq N$$
where:
(x, y) is the location of the base station;
N is the number of reporting mobile stations;
(xᵢ, yᵢ) is the location of each of the N MSs;
t_{T} is the transmission time of the marker at the base station;
t_{R}ⁱ is the time of reception of the marker at the MSᵢ; and
c is the speed of light.

4. The method according to claim 2, wherein the step of computing the location information includes computing the location information by computing time differences of arrival for signals transmitted from or received at two mobile stations.

5. The method according to claim 4, wherein the step of computing the location information by computing time differences of arrival for signals from two mobile stations includes computing the location information utilizing the equation:
$${t}_{R}^{i + 1} - {t}_{R}^{i} = \frac{\sqrt{{( x - {x}_{i + 1} )}^{2} + {( y - {y}_{i + 1} )}^{2}}}{c} - \frac{\sqrt{{( x - {x}_{i} )}^{2} + {( y - {y}_{i} )}^{2}}}{c} , \\ 1 \leq i \leq N - 1 \qquad$$
where:
(x, y) is the location of the base station;
N is the number of reporting mobile stations;
(xᵢ, yᵢ) is the location of each of the N MSs;
t_{R}ⁱ is the time of reception of the signal from MSᵢ;
t_{R}ⁱ⁺¹ is the time of reception of the signal from MSᵢ₊₁; and
c is the speed of light.

6. A method of synchronizing transmissions from a base station in a wireless communication system in which the location of the base station is not known, said method comprising:
determining location information and transmit time for the base station, said location and transmit time determining step comprising:
receiving information in the base station or other network node from at least three reporting mobile stations having Global Positioning System (GPS) capability, said information including for each reporting mobile station, GPS location information, an identity of a marker in a received downlink frame, and the GPS time at which the mobile station received the marker; and
computing in the base station or other network node, the location information for the base station and the GPS time corresponding to the base station's transmission time for the marker utilizing the received information; and
adjusting the base station transmission timing to satisfy a pre-determined relationship between the base station's transmission time for the marker and GPS time.

7. A method of synchronizing transmissions from a base station in a wireless communication system in which the location of the base station is not known, said method comprising:
determining location information for the base station, said location determining step comprising:
receiving information in the base station or other network node from at least three reporting mobile stations having GPS capability, said information including for each reporting mobile station, Global Positioning System (GPS) location information, an identity of a marker in a received downlink frame, and the GPS time at which the mobile station received the marker; and
computing in the base station or other network node, the location information for the base station utilizing the received information;
calculating a distance from the base station to a given reporting mobile station based on the received GPS location of the given mobile station and the computed location information for the base station;
computing a propagation delay between the base station and the given mobile station;
computing a GPS time corresponding to the transmission time for the marker; and
adjusting the base station transmission timing to satisfy a pre-determined relationship between the base station's transmission time for the marker and GPS time.

8. A method of determining location information for a mobile station which is not Global Positioning System (GPS) capable, said non-GPS-capable mobile station operating in a wireless communication system in which the location of a given base station in communication with the non-GPS-capable mobile station is not known, said method comprising:
computing location and transmit time information for the given base station based upon GPS location and timing information received by the given base station from at least three GPS-capable mobile stations; and
determining the location information for the non-GPS-capable mobile station utilizing the computed location and transmit time of the given base station and the locations and transmit times of at least two other base stations in communication with the non-GPS-capable mobile station.

9. The method according to claim 8, wherein the step of computing location and transmit time information for the given base station includes:
receiving GPS location and timing information in the given base station or other network node from at least three reporting mobile stations having GPS capability, said information including for each reporting mobile station, GPS location information, an identity of a marker in a received downlink frame, and the GPS time at which the mobile station received the marker;
computing the location information for the given base station utilizing the received information; and
computing a GPS time corresponding to the transmission time of the marker utilizing the received information

10. The method according to claim 9, wherein the step of determining the location information for the non-GPS-capable mobile station includes:
measuring time-of-arrival information for an uplink signal transmitted by the non-GPS-capable mobile station, wherein the uplink signal is received at the given base station and the at least two other base stations in communication with the non-GPS-capable mobile station; and
computing the location of the non-GPS-capable mobile station from the time of arrival information and the computed base station location and transmit time information.

11. The method according to claim 9, wherein the step of determining the location information for the non-GPS-capable mobile station includes:
measuring time-of-arrival information for an uplink signal transmitted by the non-GPS-capable mobile station, wherein the uplink signal is received at the given base station and the at least two other base stations in communication with the non-GPS-capable mobile station;
calculating time differences of arrival for the uplink signal at the base stations; and
computing the location of the non-GPS-capable mobile station from the time differences of arrival and the computed base station location and transmit time information.

12. The method according to claim 9, wherein the step of determining the location information for the non-GPS-capable mobile station includes:
measuring time-of-arrival information of a downlink signal at the non-GPS-capable mobile station, wherein the downlink signal is transmitted by the given base station and the at least two other base stations in communication with the non-GPS-capable mobile station; and
computing the location of the non-GPS-capable mobile station from the time of arrival information and the computed base station location and transmit time information.

13. The method according to claim 9, wherein the step of determining the location information for the non-GPS-capable mobile station includes:
measuring time-of-arrival information of downlink signals at the non-GPS-capable mobile station, wherein the downlink signals are transmitted by the given base station and the at least two other base stations in communication with the non-GPS-capable mobile station; and
calculating time differences of arrival for the downlink signals at the non-GPS-capable mobile station; and
computing the location of the non-GPS-capable mobile station from the time differences of arrival and the computed base station location and transmit time information.

14. The method according to claim 9, wherein the step of computing a GPS time corresponding to the transmission time of the marker includes:
calculating a distance from the given base station to a given GPS-capable mobile station based on the received GPS location of the given GPS-capable mobile station and the computed location information for the given base station;
computing a propagation delay between the given base station and the given GPS-capable mobile station; and
computing a GPS time corresponding to the transmission time for the marker.

15. The method according to claim 9, wherein the step of determining the location information for the non-GPS-capable mobile station includes:
modifying the computed base station transmission times to synchronize base stations by adjusting the given base station transmission timing to satisfy a predetermined relationship between the given base station's transmission time for the marker and GPS time.

16. In a wireless communication system, an arrangement for determining location information for the base station, said arrangement comprising:
communication means for receiving Global Positioning System (GPS) location and timing information from at least three mobile stations having GPS capability; and
a location computation unit for computing the location information for the base station utilizing the received GPS location and timing information.

17. The arrangement of claim 16, wherein the GPS location and timing information received from each of the at least three mobile stations includes an identity of a marker in a received downlink frame and the GPS time at which the mobile station received the marker.

18. The arrangement of claim 16, wherein the marker is a frame number of the received downlink frame, and the GPS time is the GPS time at the start of the received frame.

19. The arrangement of claim 16, wherein the base station is located in a wireless local area network (WLAN).

20. The arrangement of claim 16, wherein the base station is located in an ad-hoc/multi-hop wireless network.

21. In a wireless communication system in which location information for a base station is not known, an arrangement for synchronizing transmissions from the base station, said arrangement comprising:
communication means for receiving information in the base station or other network node from at least three reporting mobile stations having Global Positioning System (GPS) capability, said information including for each reporting mobile station, GPS location information, an identity of a marker in a received downlink frame, and the GPS time at which the mobile station received the marker;
a location computation unit for computing the location information and GPS transmission time of the marker for the base station utilizing the received information; and
means for adjusting the base station transmission timing to satisfy a pre-determined relationship between the base station's transmission time for the marker and GPS time.

22. The arrangement of claim 21, wherein the marker is a frame number of the received downlink frame, and the GPS time is the GPS time at the start of the received frame.

23. In a wireless communication system in which location information for a base station is not known, an arrangement for synchronizing transmissions from the base station, said arrangement comprising:
communication means for receiving information in the base station or other network node from at least three reporting mobile stations having Global Positioning System (GPS) capability, said information including for each reporting mobile station, GPS location information, an identity of a marker in a received downlink frame, and the GPS time at which the mobile station received the marker;
a location computation unit for computing the location information for the base station utilizing the received information;
means for computing a propagation delay between the base station and a given mobile station based on the received GPS location of the given mobile station and the computed location information for the base station;
means for computing a GPS time corresponding to the transmission time for the marker based on the GPS time at which the mobile station received the marker and the computed propagation delay; and
means for adjusting the base station transmission timing to satisfy a pre-determined relationship between the base station's transmission time for the marker and GPS time.

24. The arrangement of claim 23, wherein the marker is a frame number of the received downlink frame, and the GPS time is the GPS time at the start of the received frame.

25. An arrangement for determining location information for a mobile station which is not Global Positioning System (GPS) capable, said non-GPS-capable mobile station operating in a wireless communication system in which the location of a given base station in communication with the non-GPS-capable mobile station is not known, said arrangement comprising:
a location computation unit for computing location information and transmit time information for the given base station based upon GPS location and timing information received from at least three GPS-capable mobile stations; and
a mobile location unit for determining the location information for the non-GPS-capable mobile station utilizing the location and transmit time of the given base station and the locations and transmit times of at least two other base stations in communication with the non-GPS-capable mobile station.

26. The arrangement according to claim 25, wherein the location computation unit includes:
communication means for receiving GPS location and timing information in the given base station or other network node from at least three reporting mobile stations having GPS capability, said information including for each reporting mobile station, GPS location information, an identity of a marker in a received downlink frame, and the GPS time at which the mobile station received the marker; and
means for computing the location information and GPS transmission time of the marker for the given base station utilizing the received information.

27. The arrangement according to claim 26, wherein the means for computing GPS transmission time of the marker includes:
a distance computation unit for computing a distance from the given base station to a given GPS-capable mobile station based on the received GPS location of the given mobile station and the computed location information for the given base station;
a delay computation unit for computing a propagation delay between the given base station and the given GPS-capable mobile station; and
means for computing a GPS time corresponding to the transmission time for the marker.

28. The arrangement according to claim 26, wherein the means for computing GPS transmission time of the marker includes:
means for adjusting the given base station transmission timing to satisfy a predetermined relationship between the given base station's transmission time for the marker and GPS time.

29. The arrangement according to claim 26, wherein the mobile location unit includes:
means for measuring time-of-arrival information for an uplink signal transmitted by the non-GPS-capable mobile station, wherein the uplink signal is received at the given base station and the at least two other base stations in communication with the non-GPS-capable mobile station; and
means for triangulating the location of the non-GPS-capable mobile station from the measured time-of-arrival information.

30. The arrangement according to claim 26, wherein the mobile location unit includes:
means for measuring time-of-arrival information for an uplink signal transmitted by the non-GPS-capable mobile station, wherein the uplink signal is received at the given base station and the at least two other base stations in communication with the non-GPS-capable mobile station;
means for calculating time differences of arrival for the uplink signal at the base stations; and
means for computing the location of the non-GPS-capable mobile station from the time differences of arrival.

31. The arrangement according to claim 26, wherein the mobile location unit includes:
means for measuring time-of-arrival information for downlink signals received by the non-GPS-capable mobile station, wherein the downlink signals are transmitted by the given base station and the at least two other base stations in communication with the non-GPS-capable mobile station; and
means for triangulating the location of the non-GPS-capable mobile station from the measured time-of-arrival information.

32. The arrangement according to claim 26, wherein the mobile location unit includes:
means for measuring time-of-arrival information for downlink signals received by the non-GPS-capable mobile station, wherein the downlink signals are transmitted by the given base station and the at least two other base stations in communication with the non-GPS-capable mobile station;
means for calculating time differences of arrival for the downlink signals at the base stations; and
means for computing the location of the non-GPS-capable mobile station from the time differences of arrival.

33. In a cellular network having a plurality of base stations, a method of propagating location information through the network, wherein initial location information is not known for at least some of the base stations, and a plurality of mobile stations operate within the network, wherein some of the mobile stations are Global Positioning System (GPS)-capable and others of the mobile stations are non-GPS-capable, said method comprising:
computing location and synchronization information for at least one of three base stations (BS1, BS2, and BS3) based on GPS location and GPS time information received from at least three GPS-capable mobile stations in communication with the at least one base station;
computing location information for at least one non-GPS-capable mobile station in communication with BS1, BS2, and BS3 based on the computed location information for BS1, BS2, and BS3 and time-of-arrival information for signals from the non-GPS-capable mobile stations received at BS1, BS2, and BS3; and
computing location information for a fourth base station (BS4) in communication with three mobile stations comprising a combination of non-GPS-capable mobile stations and GPS-capable mobile stations based on GPS-location and GPS-time information received from the GPS-capable mobile stations and time differences of arrival information reported by the non-GPS-capable mobile station, said time differences of arrival comprising time-of-arrival information for signals transmitted from BS4 and one of BS1, BS2, and BS3.

34. The method according to claim 33, wherein one of BS1, BS2, and BS3 is a fixed or mobile relay station.

35. The method according to claim 33, wherein one of the mobile stations is a fixed or mobile relay station.

36. In a cellular network having a plurality of base stations, a method of propagating location information through the network, wherein initial location information is not known for at least some of the base stations, and a plurality of mobile stations operate within the network, wherein some of the mobile stations are Global Positioning System (GPS)-capable and others of the mobile stations are non-GPS-capable, said method comprising:
computing location and synchronization information for at least one of three base stations (BS1, BS2, and BS3) based on GPS location and GPS time information received from at least three GPS-capable mobile stations in communication with the at least one base station;
computing location information for a non-GPS-capable mobile station in communication with BS1, BS2, and BS3 based on the computed location information for BS1, BS2, and BS3 and time-of-arrival information for signals from the non-GPS-capable mobile stations received at BS1, BS2, and BS3; and
computing location information for a fourth base station (BS4) in communication with the non-GPS-capable mobile station and two of the GPS-capable mobile stations based on GPS-location and GPS-time information received from the GPS-capable mobile stations and time differences of arrival reported by the non-GPS-capable mobile station, said time differences of arrival comprising time-of-arrival information for signals transmitted from BS4 and one of BS1, BS2, and BS3.

37. A method of determining location and transmit timing information for a given base station in a wireless communication system, said method comprising:
receiving or computing in the given base station or other network node, locations of at least three mobile stations; and
receiving in the given base station or other network node, timing information from the at least three mobile stations, said timing information comprising GPS time of arrival of a signal received at the mobile station from the given base station if the mobile station is GPS-capable, and comprising time differences of arrival of signals from the given base station and a different base station with known location and transmit timing if the mobile station is non-GPS-capable; and
computing in the given base station or other network node, the location and transmit timing information for the given base station utilizing the received GPS time of arrival or time difference of arrival information from the at least three mobile stations, the locations of the at least three mobile stations, and location and timing information for the base stations with known location and transmit timing.

38. The method according to claim 37, wherein the step of receiving GPS time of arrival information includes receiving from each of the at least three mobile stations, an identity of a marker in a received downlink frame and the GPS time at which the mobile station received the marker.

39. The method according to claim 37, wherein the step of receiving time difference of arrival information includes receiving from each of the at least three mobile stations, an identity of a marker in a received downlink frame and the differences in the time at which the mobile station received the marker from the given base station and the different base station with known location and transmit timing.

40. The method according to claim 38, wherein the step of computing the location and transmit timing information includes computing the location and transmit timing information utilizing the equation.
$${t}_{R}^{i} = {t}_{T} + \frac{\sqrt{{( x - {x}_{i} )}^{2} + {( y - {y}_{i} )}^{2}}}{c} , 1 \leq i \leq N$$
where:
(x, y) is the location of the base station;
N is the number of reporting mobile stations;
(xᵢ, yᵢ) is the location of each of the N MSs:
t_{T} is the transmission time of the marker at the base station;
t_{R}ⁱ is the time of reception of the marker at the MSᵢ; and
c is the speed of light.

41. The method according to claim 37, wherein one of the base stations is a fixed or mobile relay station.

42. The method according to claim 37, wherein one of the mobile stations is a fixed or mobile relay station.

43. A method of determining a transmission time of a downlink signal transmitted from a base station in a wireless communication system in which the location of the base station is known, said method comprising:
receiving information in the base station or another network node from at least one reporting mobile station having Global Positioning System (GPS) capability, said information including for each reporting mobile station, GPS location information, an identity of a marker in a received downlink frame, and a GPS time at which the mobile station received the marker; and
computing in the base station or other network node, the GPS time corresponding to the base station's transmission time for the marker utilizing the received information.
